(19) United States
(12) Patent Application Publication
(10) Pub. No.: US 2012/0324391 A1
(43) Pub. Date: Dec. 20, 2012

(54) PREDICTIVE WORD COMPLETION

(75) Inventor: Mark Tocci, Seattle, WA (US)

(73) Assignee: Microsoft Corporation, Redmond, WA (US)

(21) Appl. No.: 13/162,319

(22) Filed: Jun. 16, 2011

(51) Int. Cl. G06F 3/048

(52) U.S. Cl. 715/773

(57) ABSTRACT

This document describes predictive word completion. By predicting complete words after each user input on an input device, e.g., a virtual keyboard, a user may readily receive computer aid when inputting characters to increase accuracy and speed of the user's typing.

### BACKGROUND

The use of soft keyboards, e.g., digital and/or touch keyboards, is ever increasing, as well as a both users' and developers' desire for improved performance and accuracy. Often, soft keyboards may be used for devices that are too small to implement traditional keyboards. At least in part due to the small size of these devices, typing on soft keyboards can be slow and frustrating to users. For instance, smartphone users often type with only one thumb due to the size of the soft keyboard implemented on the smartphone and/or the size of the smartphone itself Smartphone users can also become frustrated by the size of their thumbs affecting the accuracy of their typing due to inadvertently touching wrong keys.

Traditional techniques were developed to assist users by predicting words. Those techniques, however, are often slow or wrongly predict words due to the user's typing errors. This can be inefficient, time consuming, and can frustrate users.

### SUMMARY

This document describes techniques for predictive word completion. In some embodiments, complete words are predicted after each user input is received on an input device, such as a virtual keyboard. As part of the prediction techniques, user input ambiguities, such as a user input corresponding to a set of characters, can be resolved to a most-likely correct character, which is then used in predicting the complete words. Thus, a user may readily receive computer aid when inputting characters via an input device to increase accuracy and speed of the user's typing.

This summary is provided to introduce simplified concepts of predictive word completion that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of predictive word completion are described with reference to the following drawings. The same numbers are used throughout the drawings to reference like features and components:

FIG. 1 illustrates an example system in which techniques for predictive word completion can be implemented.

FIG. 2 illustrates an example implementation of predictive word completion in accordance with one or more embodiments.

FIG. 3 illustrates an example implementation of predictive word completion in accordance with one or more embodiments.

FIG. 4 illustrates example method(s) of predictive word completion in accordance with one or more embodiments.

FIG. 5 illustrates additional example method(s) of predictive word completion in accordance with one or more embodiments.

FIG. 6 illustrates an example device in which techniques for predictive word completion can be implemented.

### DETAILED DESCRIPTION

### Overview

This document describes techniques for predictive word completion. By predicting complete words after each user input on an input device, e.g., a virtual keyboard, a user may readily receive computer aid when inputting characters to increase accuracy and speed of the user's typing.

Consider a case where a virtual keyboard receives a single user input that can correspond to multiple characters. Assume here that a user inputs a set of characters on a virtual keyboard by inadvertently touching the virtual keyboard in-between characters. Assume here that the user intended to input the letter “t” on the virtual keyboard but instead touched in-between the letters “t,” “r,” and “f.” It is difficult to determine which letter was intended by the user. In this example, techniques for predictive word completion determine which character was intended by the user and uses that determination to predict complete words.

This is but one example of how the techniques for predictive word completion predict complete words after each user input—other are described below. This document now turns to an example environment in which the techniques can be embodied, after which various example methods for performing the techniques are described.

### EXAMPLE ENVIRONMENT

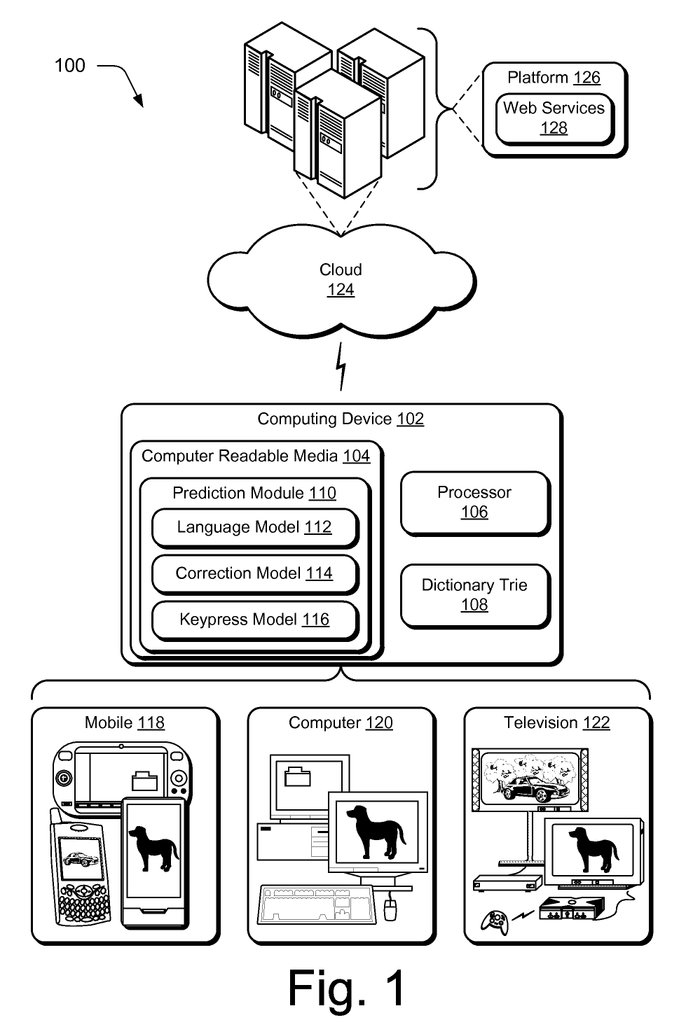

FIG. 1 is an illustration of an example environment 100 in which the techniques may operate to predict complete words. Environment 100 includes one or more computing device(s) 102. Computing device 102 includes one or more computer-readable media (“media”) 104, processor(s) 106, a prediction module 108, and dictionary trie(s) 110. Prediction module 108 is representative of functionality associated with predicting complete words for a user after each user input and to cause operations to be performed that correspond with predictive word completion. Prediction module 108 may utilize a language model 112, a correction model 114, and a keypress model 116 to conduct a beam search for predicting words likely to be used by the user. The beam search may involve a finite width of best alternative words up to the point of the search, e.g., top 1000, or may be configured to limit the number of alternatives. The language model 112, the correction model 114, and the keypress model 116 are discussed further below.

As shown in FIG. 1, computing device 102 may be configured in a variety of ways. For example, computing device 102 can be a traditional computer (e.g., a desktop personal computer, laptop computer, and so on), a mobile station, an entertainment appliance, a set-top box communicatively coupled to a television, a wireless phone, a netbook, a game console, and so forth. Thus, computing device 102 may range from full resource devices with substantial memory and processor resources (e.g., personal computers, game consoles) to a low-resource device with limited memory and/or processing resources (e.g., traditional set-top boxes, hand-held game consoles). Computing device 102 may also relate to software that causes the computing device 102 to perform one or more operations.

The dictionary trie 110 includes an ordered tree structure storing an array of strings. Unlike a binary search tree, a node in the dictionary trie 110 may not store a key or virtual key associated with that node. Rather, the node's position in the trie may show which key is associated with the node. Additionally, the node may have descendants that have a common prefix of a string associated with the node, whereas a root of the trie may be associated with an empty string. Also, values may be associated with leaves and/or inner nodes that correspond to keys or virtual keys of interest rather than a value being associated with each node in the trie. The trie may also include one or more subtrees expandable for predictive word completion techniques as further described below.

As shown in FIG. 1, multiple devices can be interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means. In one embodiment, this interconnection architecture enables functionality to be delivered across multiple devices to provide a common and seamless experience to the user of the multiple devices. Each of the multiple devices may have different physical requirements and capabilities, and the central computing device may use a platform to enable the delivery of an experience to the device that is both tailored to the device and yet common to all devices. In one embodiment, a “class” of target device is created and experiences are tailored to the generic class of devices. A class of devices may be defined by physical features, usage, or other common characteristics of the devices.

For example, as previously described, the computing device 102 may assume a variety of different configurations, such as for mobile 118, computer 120, and television 122 uses. Each of these configurations has a generally corresponding screen size and thus the computing device 102 may be configured accordingly to one or more of these device classes in this example system 100. For instance, the computing device 102 may assume the mobile 118 class of device which includes mobile phones, portable music players, game devices, and so on. The mobile 118 class of device may also include other handheld devices such as personal digital assistants (PDA), mobile computers, digital cameras, and so on. The computing device 102 may also assume a computer 120 class of device that includes personal computers, laptop computers, tablet computers, netbooks, and so on. The television 122 configuration includes configurations of devices that involve display on a generally larger screen in a casual environment, e.g., televisions, set-top boxes, game consoles, and so on. Thus, the techniques described herein may be supported by these various configurations of the computing device 102 and are not limited to the specific examples described in the following sections.

The cloud 124 is illustrated as including a platform 126 for web services 128. The platform 126 abstracts underlying functionality of hardware (e.g., servers) and software resources of the cloud 124 and thus may act as a “cloud operating system.” For example, the platform 126 may abstract resources to connect the computing device 102 with other computing devices. The platform 126 may also serve to abstract scaling of resources to provide a corresponding level of scale to encountered demand for the web services 128 that are implemented via the platform 126. A variety of other examples are also contemplated, such as load balancing of servers in a server farm, protection against malicious parties (e.g., spam, viruses, and other malware), and so on. Thus, web services 128 and other functionality may be supported without the functionality “having to know” the particulars of the supporting hardware, software, and network resources.

Accordingly, in an interconnected device embodiment, implementation of functionality of the prediction module 108 may be distributed throughout the system 100. For example, the prediction module 108 may be implemented in part on the computing device 102 as well as via the platform 126 that abstracts the functionality of the cloud 124.

Further, the functionality may be supported by the computing device 102 regardless of the configuration. For instance, the predictive word completion techniques supported by the prediction module 108 may be performed in conjunction with touchscreen functionality in the mobile 118 configuration, track pad functionality of the computer 120 configuration, camera functionality as part of support of a natural user interface (NUI) that does not involve contact with a specific input device in the television 122 example, and so on. Any of these configurations may include a virtual keyboard with virtual keys to allow for user input. Further, performance of the operations to detect and recognize the inputs to identify a particular input may be distributed throughout the system 100, such as by the computing device 102 and/or the web services 128 supported by the platform 126 of the cloud 124. Further discussion of the predictive word completion supported by the prediction module 108 may be found in relation to the following sections.

These and other capabilities, as well as ways in which entities of FIG. 1 act and interact, are set forth in greater detail below. Note also that these entities may be further divided, combined, and so on. For instance, prediction module 110 may operate on a separate device having remote communication with computing device 102, such as residing on a server or on a separate computing device 102. Prediction module 110 may also be internal or integrated with platform 126, in which prediction module 110's and platform 126's actions and interaction may be internal to one entity. Thus, the environment 100 of FIG. 1 illustrates but one of many possible environments capable of employing the described techniques.

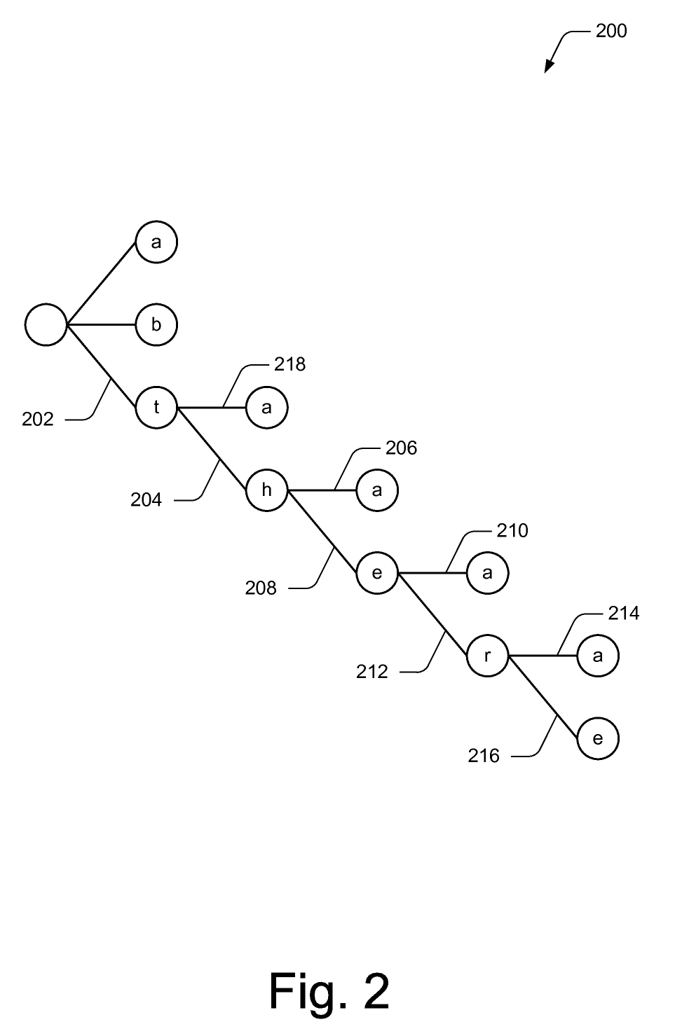

FIG. 2 shows an example trie subtree 200 that is a subtree of the dictionary trie 110 in an example implementation of predictive word completion in accordance with one or more embodiments. The trie subtree may be configured in a variety of configurations. For instance, the trie subtree may be configured as a maximum word probability encoded trie. In addition, the root node, e.g., the leftmost node, is in this example associated with an empty string. Traditionally, each character in a language may be associated with a probability based on the empty string, which indicates that a character selected will be the first letter in a word. Further, in traditional techniques, each node of the trie is associated with a probability that identifies the likelihood of a particular character being selected based on the previous character. In contrast to traditional techniques, however, the prediction module 108 may utilize maximum probabilities for characters or a sequence of characters to identify most-probable words. That is, each word formed in the dictionary trie may be associated with a probability rather than each node on the trie being associated with a probability. By way of example, the dictionary trie 110 may store a probability corresponding to a unigram probability of a most-frequent word beginning with a particular character or series of characters. This may allow for less storage and faster processing because the characters forming a word may be associated with a same probability, which may provide for less calculation.

When a user inputs a character, the prediction module 108 may calculate a maximum probability associated with the character and use that maximum probability to identify a most-probable word beginning with the inputted character. The most-probable word may include a most-frequently used word, such as a word most-frequently used in a particular spoken or written language or a word most-frequently used by a particular user. For example, assume that a user inputs a character “t”. At branch 202, the prediction module 108 may determine p(max(t)), which may be associated with a maximum probable word beginning with “t”. By way of example and not limitation, the resulting word may include the word “the”. Using the most-likely word, the prediction module 108 may then identify subsequent child characters of “t” in the word “the”, such as “h” and “e”, and follow the paths in the trie subtree that correspond to those subsequent child characters, which may correspond to additional words.

For instance, because the most-likely word in this example is “the”, the prediction module 108 may identify at branch 204 that p(max(th)) is equivalent to p(max(t)), which is also equivalent to p(max(the)). The prediction module may then attempt to identify other likely words by expanding paths in the subtree to other characters following the children of “t” in the word “the”. For example, the prediction module 108 may analyze p(max(tha)) at branch 206 and also p(max(the)) at branch 208. In addition, the prediction module may analyze p(max(thea)) at branch 210, and p(max(ther)) at branch 212, p(max(thera)) at branch 214, and p(max(there)) at branch 216, and so on. Other paths are also expandable and are not limited to the paths illustrated in this example. Each of the paths formed by the children of “t” may be expanded until the paths are exhausted.

At least some paths in the trie subtree, however, may not be expanded. This lack of expansion for these other paths may reduce time and resources used for predicting complete words, as well as reduce errors in the predictions. By way of example, branch 218 is not expanded here because that particular node does not form a path in the trie subtree from one or more children of “t” in the maximum probable word “the”. Unlike traditional techniques, however, no branches are expanded to paths that do not create words in the dictionary. For instance, the prediction subtree avoids expanding the trie subtree to calculate the probability of the letters “thq” because no words exist in the English dictionary that begin with those letters. Avoiding such calculations may limit the alternatives identified and may increase speed and accuracy of the predictions.

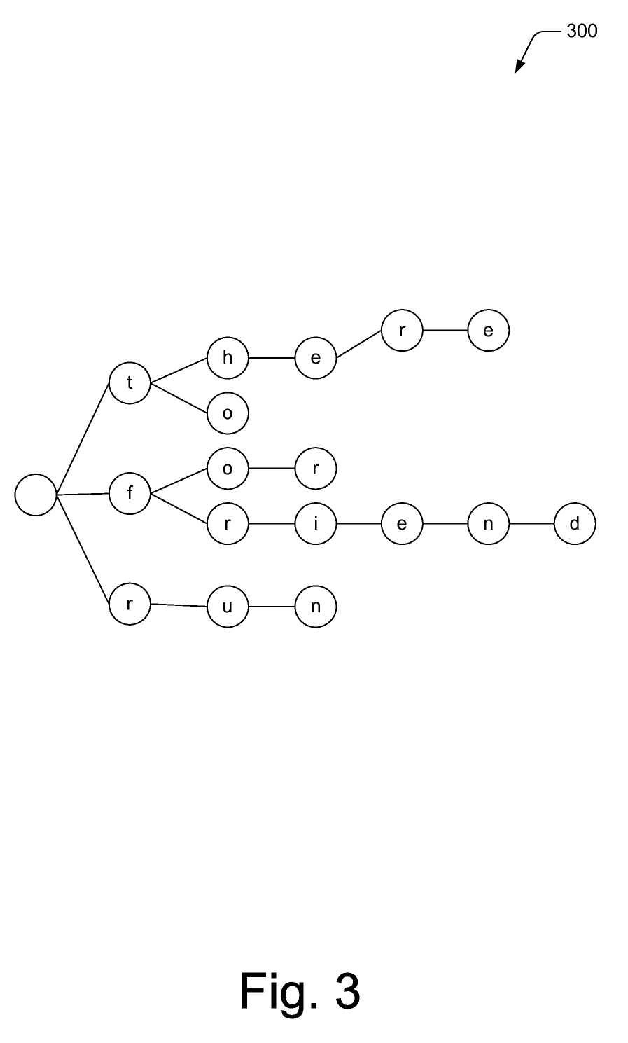

FIG. 3 illustrates a trie subtree 300 in accordance with one or more embodiments of predictive word completion. The root node in the trie subtree 300 may include an empty string. Assume that a user attempts to input the letter “t” on a virtual keyboard, but the user touches an area located in-between virtual keys “t,” “f,” and “r” on the virtual keyboard. The prediction module 108 may identify which character the user intended to touch by using the keypress model 116. The keypress model 116 may be configured to identify a selection probability for each character involved in the user input based on a percentage of the area selected by the user within the sensing boundaries of each virtual key.

As the user inputs successive characters of a word, the prediction module 108 may utilize the language model 112 to identify valid complete words in a dictionary pertaining to a certain language. In addition, the prediction module 108 may correct user misspellings as the user types after each user input based on the correction model 114.

Continuing with the above example, FIG. 3 illustrates an example trie subtree expanded to the top six words that are most-likely correct based on the user's user input located in-between the “t,” “f,” and “r.” In this example, these words may include “the,” “there,” “to,” “for,” “friend,” and “run.” The prediction module 108 may expand any number of words in the trie subtree and/or may avoid expanding words in the trie subtree that are not included in the top n words. Rather, the only words expanded in the trie subtree may be those that are included in the top n words. For example, the word “thalamus” may not be expanded because it may have a low probability such that there are n words that are more likely to be correct and which have higher probabilities. By expanding fewer words, the number of alternatives may be limited and fewer resources and less time may be consumed in predicting most-likely words. Additionally or alternatively, the prediction module 108 may expand a same number of branches of the trie subtree as a total number of characters in a predefined number of words involved.

The prediction module 108 determines which words to avoid expanding and which words in the trie subtree to expand by analyzing a combination of probabilities identified by the keypress model 116, the correction model 114, and the language model 112. Consider Table 1, which illustrates an example of how the prediction module 108 may determine which words to expand in the trie subtree.

TABLE 1

| | Selection | Trie | Total |
|---|---|---|---|
| List | Probability | Probability | Probability |
| r | .5 | .01 | .005 |
| t | .3 | .06 | .018 |
| f | .2 | .02 | .004 |
| th | .3 | .06 | .018 |
| the | .3 | .06 | .018 |
| there | .3 | .05 | .015 |

For ease of explanation, Table 1 does not include probabilities for corrections based on the correction model 114. Continuing with the above example, assume the user touched an area on the virtual keyboard between the virtual keys “r,” “t,” and “f.” Upon receiving this user input, the keypress model 116 identifies a selection probability for each character involved in the user input. For example, the selection probability for “r” may be 0.5 based on a percentage of an area on the virtual keyboard touched by the user that corresponds with the virtual “r” key, whereas “t” may have a selection probability of 0.3 and “f” may have a selection probability of 0.2. Next, the prediction module 108 identifies the trie probability of each of those characters. Here, the trie probability for a character may include p(max) of the character. In this example, p(max(r)) is 0.01, p(max(t)) is 0.06, and p(max(f)) is 0.02. A total probability may then be determined based on the product of the selection probability and the trie probability. A correction probability is provided by the correction model 114 and can be included in the total probability calculation. In this example, although the virtual “r” key received the greatest percentage of the user's touch, “t” is the most-likely character to pursue based on a comparison of the total probabilities of “r,” “t,” and “f.” Therefore, the prediction module 108 may then expand the trie subtree under “t,” following p(max(t)) to identify the top n words that begin with the letter “t.”

By way of example, Table 1 continues with probabilities associated with children of “t,” such as “th,” “the,” and “there.” Other example children are also contemplated and are not limited to the example shown in Table 1. As shown in Table 1, the total probabilities of “th” and “the” are the same as the total probability of “t.” In addition, the prediction module 108 may compute the total probability of the word “there” because the letters “re” are children of “t” in accordance with the word “the.” The prediction module 108 may continue analyzing probabilities associated with children of “t” until the top n words are identified and/or until the paths in the trie subtree associated with the children of “t” are exhausted. Once the top n words are identified, computation ceases and the top n words are added to a queue.

If the user enters an additional character, the prediction module 108 may repeat the above described process to predict a new list of top n words that are now based on a combination of the characters entered by the user. If, however, a second character entered by the user corresponds with the maximum probability of the first character, then the top n words may have been identified and placed in the queue. Accordingly, the prediction model 108 often performs little to no additional calculation, or simply identifies words already placed in the queue. Thus, rather than expanding the entire trie subtree, the prediction module 108 expands only the top n words based on maximum probabilities associated with a character or sequence of characters corresponding to probabilities associated with complete words.

In addition, probabilities associated with words in the language model may be updated in real time based on user-specific probabilities associated with complete words used by a particular user. By way of example, users may tend to have their own styles of writing or speaking along with frequently used words corresponding to their particular style. As certain complete words are used, the probabilities associated with those words are updated to indicate that those words are likely to be used again. Therefore, the predicted words for a particular user can be user-specific based on a frequency with which that particular user uses certain complete words.

The probabilities associated with the words are updated in real time by adding one to a count associated with a total probability that is associated with a word used by the user. The word used by the user increases the likelihood of that word being used again. Adding one to a count associated with the probability for that word affects the total probability for that word, whereas the maximum probability of a single character may remain unaffected.

Consider, by way of example, a case where a doctor often uses the word “thalamus” to describe a portion of the human brain. Each use of the word “thalamus” increases the likelihood of that word being determined to be correct. Therefore, although the word “thalamus” may not be a frequently used word in common English speech, it may become a likely user-specific candidate for predictive word completion specific to that doctor, or a field of endeavor.

### EXAMPLE METHODS

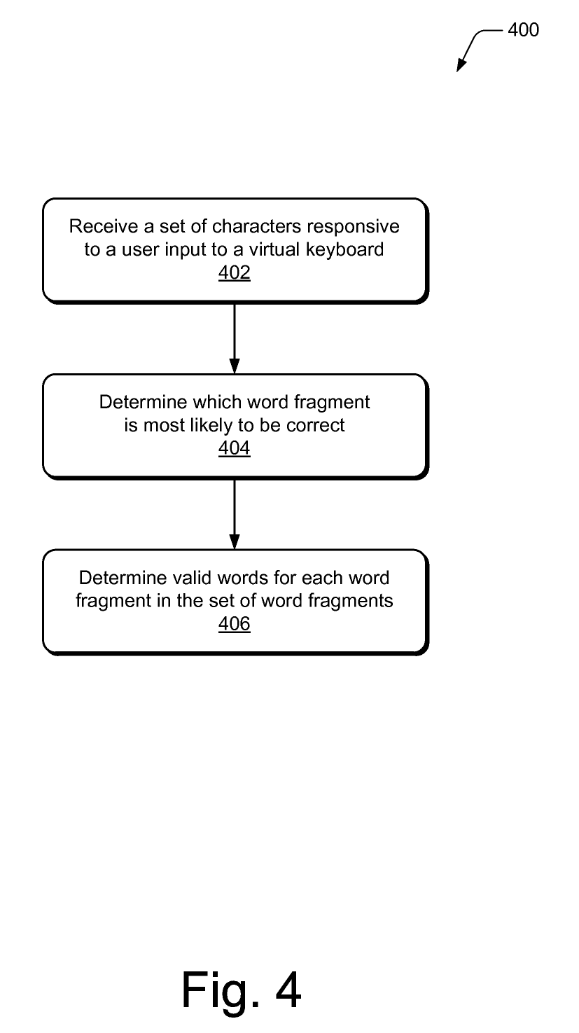

FIG. 4 depicts a method 400 for predictive word completion. This method is shown as a set of blocks that specify operations performed but is not necessarily limited to the order shown for performing the operations by the respective blocks. In portions of the following discussion reference may be made to environment 100 of FIG. 1, reference to which is made for example only.

Block 402 receives a set of characters responsive to a user input to a virtual keyboard. The user input can be received in various manners, such as by receiving a user touch on a touchscreen displaying the virtual keyboard. The set of characters may correspond to the user input and be based on characters of the virtual keyboard that are proximate a received location on the virtual keyboard of the user input. In implementations, the received location may be located between virtual keys on the virtual keyboard, thus creating ambiguity as to the user's intent. Also, the set of characters may continue a word fragment to provide a set of word fragments corresponding to the set of characters. For example, the set of characters may be combined with previously received characters to generate a word fragment and/or form a complete word.

Block 404 determines which word fragment is most-likely to be correct based on the received location, and also based on each word fragment of the set of word fragments being a valid word, a portion of a valid word, or correctable to become a valid word. The word fragment may include a beginning portion of a valid word, and/or may be based on a language model corresponding to a dictionary of valid words that pertain to one or more languages. Additionally, each word fragment in the set of word fragments may include a correctly spelled word or an incorrectly spelled but often-used word. The word fragment may also be correctable to become a valid word based on a correction model indicating that the word fragment is likely misspelled but intended to be a valid word.

In addition, the received location may indicate a probability that each character in the set of characters is correct. If, for instance, the received location of the user input is located in-between virtual keys on the virtual keyboard, the keypress model 116 calculates relative percentages for each virtual key corresponding to an area defined by the received location based on a portion of the area that is located within a sensing area assigned to each of the virtual keys involved. Using these percentages, the keypress model 116 associates a probability with characters corresponding to each virtual key involved in the user received location of the user input. With these probabilities, the keypress model 116 identifies which character is most-likely correct. In this way, the keypress model 116 can determine which character is most-likely intended by the user when the user erroneously touches multiple keys or an indiscriminant location on the virtual keyboard with a single touch.

Block 406 determines valid words for each word fragment in the set of word fragments. Block 406 may do so by identifying valid words based on a language model. Various languages may be used by the language model, such as English, Spanish, Russian, Chinese, and so on. The language model 112 uses a dictionary corresponding to a particular language to identify words that exist in that language along with correct spelling for the identified words. In addition, a word probability may be determined for each valid word to indicate a likelihood of correctness based on the language model.

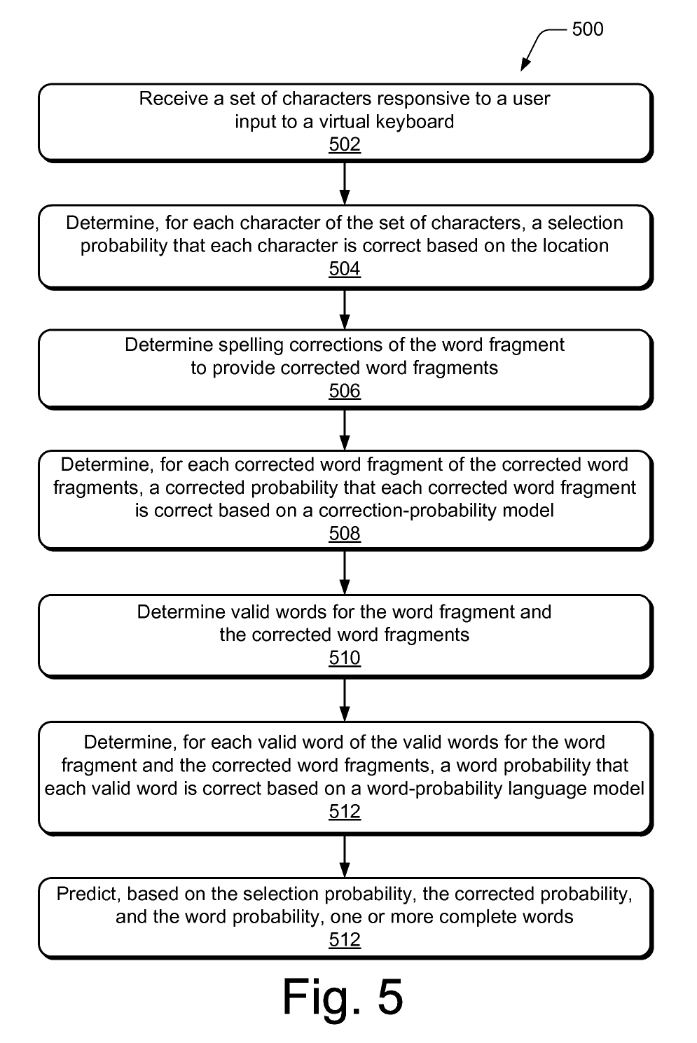

FIG. 5 depicts a method 500 for predictive word completion. This method is shown as a set of blocks that specify operations performed but is not necessarily limited to the order shown for performing the operations by the respective blocks. In portions of the following discussion reference may be made to environment 100 of FIG. 1, reference to which is made for example only.

Block 502 receives a set of characters responsive to a user input to a virtual keyboard. As noted above, the set of characters may correspond to the user input and be based on characters of the virtual keyboard that are proximate a received location on the virtual keyboard of the user input. In addition, the set of characters may continue a word fragment. By way of example, the virtual keyboard may be implemented on a touchscreen device, which allows a user to touch a location on the touchscreen device that is located in-between virtual keys, at an indiscriminant location, or on an edge of a virtual key on the virtual keyboard. Such a location may correspond to multiple virtual keys and therefore may cause some ambiguity as to which virtual key was intended by the user and/or which virtual key or keys are incorrect.

Block 504 determines, for each character of the set of characters, a selection probability that each character is correct based on the location. By way of example, the selection probability may correspond to a percentage of an area defined by the received location of the user input, where a portion of the area is located within a sensing area assigned to a particular character. Using the selection probability, a determination may be made as to which character is most-likely intended by the user.

Block 506 determines spelling corrections of the word fragment to provide corrected word fragments. By way of example, the spelling corrections may be determined using valid words and/or word fragments from the language model. The word fragment may be compared with the valid words and/or word fragments to determine most-likely words and/or word fragments for correcting the spelling of the word fragment created by the user.

Block 508 uses the corrected word fragments to determine a corrected probability that each corrected word fragment is correct based on a correction-probability model. Word fragments with higher corrected probabilities are more likely to be correct and/or intended by the user than word fragments with lower corrected probabilities. Accordingly, the corrected probability for each word fragment may aide in predicting one or more complete words.

Block 510 determines valid words for the word fragment and the corrected word fragments. By way of example, the language model 112 may be utilized to identify words that exist for one or more languages. The language model 112 may model various languages, such as Portuguese, Japanese, French, Italian, and so on, including dialects of a language.

Block 512 determines, for each valid word of the valid words for the word fragment and the corrected word fragments, a word probability that each valid word is correct based on a word-probability language model. The word-probability language model may include user-specific probabilities associated with the user's tendencies to use particular words. The word probability can be used to identify most-frequently used words, either in common speech or specific to the user.

Block 514 predicts one or more complete words based on the selection probability, the corrected probability, and the word probability. For example, these probabilities are used to determine a total probability for each of the complete words. The total probability may be used to determine complete words that are most-likely intended by the user. The complete words may be sorted and the top n words with the highest total probabilities may be presented to the user for selection.

The preceding discussion describes methods relating to predictive word completion. Aspects of these methods may be implemented in hardware (e.g., fixed logic circuitry), firmware, software, manual processing, or any combination thereof A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing mode by multiple computing devices. Further, the features described herein are platform-independent and can be implemented on a variety of computing platforms having a variety of processors.

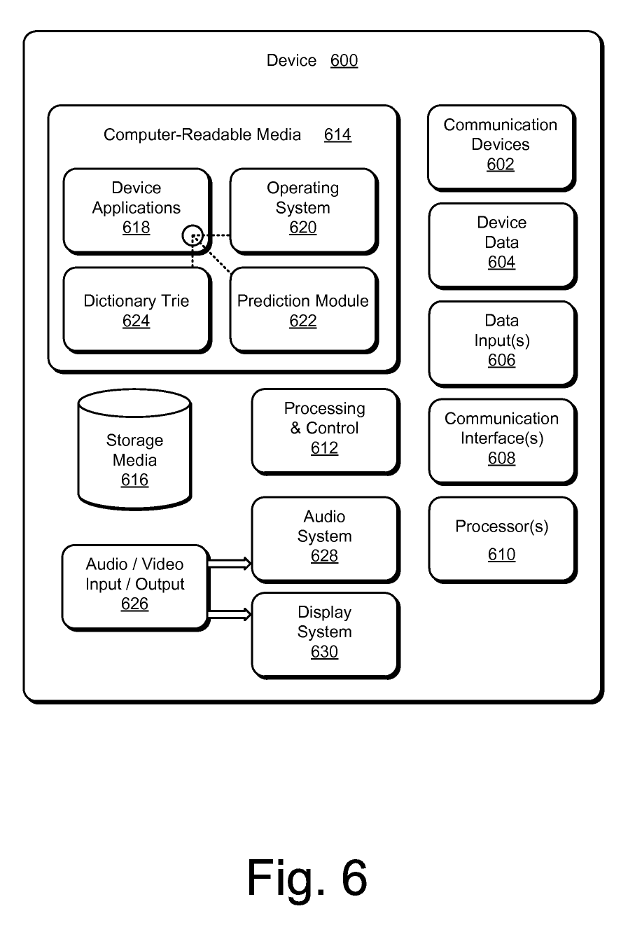

These techniques may be embodied on one or more of the entities shown in environment 100 of FIG. 1, and/or example device 600 described below, which may be further divided, combined, and so on. Thus, environment 100 and/or device 600 illustrate some of many possible systems or apparatuses capable of employing the described techniques. The entities of environment 100 and/or device 600 generally represent software, firmware, hardware, whole devices or networks, or a combination thereof In the case of a software implementation, for instance, the entities (e.g., prediction module 110 and dictionary trie 108) represent program code that performs specified tasks when executed on a processor (e.g., processor(s) 106). The program code can be stored in one or more computer-readable memory devices, such as media 104 or computer-readable media 614 of FIG. 6.

### PROBABILITY MODEL

For clarity and ease of exposition, the following model is described with reference to an example in which a user types a single word on a virtual keyboard. However, the following is not intended to be, nor is it to be interpreted as, limited to the example described. In fact, the following can easily be extended to typing phrases as well.

In the following example, a language model LM may comprise words that may be valid completed words in a particular language, whereas w̅o̅r̅d̅s̅ may include a variety of prefixes of words in the LM. Here, a word is considered to be a prefix of itself

Suppose that l₁, . . . , lₙ is a sequence of n touch locations, where each lεR² is an x and y coordinate pair. Based on the sequence of touch locations, the probability model may output both a good estimate of k*₁, . . . , k*ₙ of the user's intended sequence of keys from a key alphabet K, along with a good estimate word* of the user's intended word from a language model LM. For example,

$${k}_{1}^{*} , … , {k}_{n}^{*} , \overline{{word}^{*}} = {argmax}_{{k}_{1} , … , {k}_{n} , \overline{word}} p ( {k}_{1} , … , {k}_{n} , \overline{word} \vert {l}_{1} , … , {l}_{n} ) \qquad ( 1 )$$

Using Bayes' rule,

$$p ( {k}_{1} , … , {k}_{n} , \overline{word} \vert {l}_{1} , … , {l}_{n} ) = \frac{\begin{matrix}p ( {l}_{1} , … , {l}_{n} \vert {k}_{1} , … , {k}_{n} , \overline{word} ) \\ p ( {k}_{1} , … , {k}_{n} \vert \overline{word} ) p ( \overline{word} )\end{matrix}}{p ( {l}_{1 , … ,} {l}_{n} )} \qquad ( 2 )$$

The denominator in equation (2) is a positive constant with respect to the varied parameters and can be ignored for the maximization of equation (1). Next, an assumption can be made that an observed sequence of touch locations is conditioned only on a user's key sequence and not on the actual word the user is intending to type. That is,

p(l₃, . . . , lₙ|k₁, . . . kₙ, w̅o̅r̅d̅)=p(l₁, . . . lₙ|k₁, . . . , kₙ) (3)

This yields

$${k}_{1}^{*} , … , {k}_{n}^{*} , \overline{{word}^{*}} = {argmax}_{{k}_{1} , … , {k}_{n} , \overline{word}} p ( {l}_{1} , … , {l}_{n} \vert {k}_{1} , … , {k}_{n} ) p ( {k}_{1} , … , {k}_{n} \vert \overline{word} ) p ( \overline{word} ) \qquad ( 4 )$$

Here, the first term is referred to as the keypress probability, the second term is the correction probability, and the third term is the language probability. Continuing with the above example, assume that given the intended key, the touch location for a user input is independent of the intended virtual keys and touch locations for other user inputs:

p(l₁, . . . , lₙ|kᵢ, . . . kₙ)=p_{T}(lᵢ|k₁) . . . p_{T}(lₙ|kₙ) (5)

Using equation (5), equation (4) may be rewritten as follows:

$${k}_{1}^{*} , … , {k}_{n}^{*} , \overline{{word}^{*}} = {argmax}_{{k}_{1} , … , {k}_{n} , \overline{word}} {p}_{T} ( {l}_{1} \vert {k}_{1} ) … {p}_{T} ( {l}_{n} \vert {k}_{n} ) {p}_{C} ( {k}_{1} , … , {k}_{n} \vert \overline{word} ) {P}_{LM} ( \overline{word} ) \qquad ( 6 )$$

Equation (6) can then be used to choose word and word prefix predictions based on a sequence of touch locations. Complete word predictions are generated by filtering the outputs to include only valid completed words. Doing so may perform the optimization in equation (6) by replacing w̅o̅r̅d̅ with word. It is noted that this is a global optimization based on an entire sequence of touch locations, hence successive touches may lead to considerably different optimal predictions.

Additionally, some embodiments may include online estimation of user touch inputs. For example, as a user touches the virtual keyboard, an estimation is made as to which key has been touched and a user interface may then be updated to display the associated character. If a non-deterministic history is allowed, equation (6) may be appropriate for determining the best user touch input given a new touch location input. The resulting effect of choosing the best character with equation (6) may be one of implicit virtual key target resizing based on a history of fuzzy touch locations and probabilistic language and correction models.

Suppose, however, that the history of estimated user inputs is not modifiable, e.g., if the prediction module cannot change what is already displayed in the user interface. In this example, consider a history of user inputs h=k₀, . . . , k₁₋ᵢ along with a new touch location lᵢ. Then, w̅o̅r̅d̅(h) may be defined as a set of i+1 character length w̅o̅r̅d̅s̅ whose first i characters correspond directly to the user input history h. With these assumptions, equation (6) may be modified as follows:

$${k}_{i}^{*} , {\overline{word} ( h )}^{*} {argmax}_{{k}_{i} , \overline{word} ( h )} {p}_{T} ( {l}_{i} \vert {k}_{i} ) {p}_{C} ( {k}_{i} , h \vert \overline{word} ( h ) ) {P}_{L} ( \overline{word} ( h ) ) \qquad ( 7 )$$

Implicit virtual key-target resizing is carried out by the language and correction probability factors. Equation (7) can be implemented in practice by filtering estimations from equation (6) to preclude word alternates not contained in w̅o̅r̅d̅(h).

### EXAMPLE DEVICE

FIG. 6 illustrates various components of an example device 600 that can be implemented as any type of client, server, and/or computing device as described with reference to the previous FIGS. 1-5 to implement techniques of predictive word completion. In embodiments, device 600 can be implemented as any one or combination of a wired and/or wireless device, as any form of television client device (e.g., television set-top box, digital video recorder (DVR), etc.), consumer device, computer device, server device, portable computer device, user device, communication device, video processing and/or rendering device, appliance device, gaming device, electronic device, and/or as any other type of device. Device 600 may also be associated with a user (i.e., a person) and/or an entity that operates the device such that a device describes logical devices that include users, software, firmware, and/or a combination of devices.

Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as human utterances, user-selectable inputs, messages, music, television media content, recorded video content, and any other type of audio, video, and/or image data received from any content and/or data source.

Device 600 also includes communication interfaces 608, which can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable instructions to control the operation of device 600 and to enable techniques for predictive word completion. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable media 614, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable media 614 provides data storage mechanisms to store the device data 604, as well as various device applications 618 and any other types of information and/or data related to operational aspects of device 600. For example, an operating system 620 can be maintained as a computer application with the computer-readable media 614 and executed on processors 610. The device applications 618 can include a device manager such as any form of a control application, software application, signal-processing and control module, code that is native to a particular device, a hardware abstraction layer for a particular device, and so on.

The device applications 618 also include any system components, engines, or modules to implement techniques for predictive word completion. In this example, the device applications 618 can include a prediction module 622 and a dictionary trie 624, such as when device 600 is implemented as a predictive word completion device. The prediction module 622 and the dictionary trie 624 are shown as software modules and/or computer applications. Alternatively or in addition, the prediction module 622 and/or the dictionary trie 624 can be implemented as hardware, software, firmware, or any combination thereof

Device 600 also includes an audio and/or video rendering system 626 that generates and provides audio data to an audio system 628 and/or generates and provides display data to a display system 630. The audio system 628 and/or the display system 630 can include any devices that process, display, and/or otherwise render audio, display, and image data. Display data and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 628 and/or the display system 630 are implemented as external components to device 600. Alternatively, the audio system 628 and/or the display system 630 are implemented as integrated components of example device 600.

### CONCLUSION

Although embodiments of techniques and apparatuses for predictive word completion have been described in language specific to features and/or methods, it is to be understood that the subject of the appended claims is not necessarily limited to the specific features or methods described. Rather, the specific features and methods are disclosed as example implementations for predictive word completion.

What is claimed is:

1. A computer-implemented method, comprising:
receiving a set of characters responsive to a user input to a virtual keyboard, the set of characters corresponding to the user input and based on characters of the virtual keyboard that are proximate a received location on the virtual keyboard of the user input, the set of characters continuing a word fragment to provide a set of word fragments corresponding to the set of characters;
determining which word fragment is most-likely to be correct based on:
the received location; and
each word fragment of the set of word fragments being a valid word, a portion of a valid word, or correctable to become a valid word.

2. A computer-implemented method as recited in claim 1, wherein the received location indicates a probability that each character in the set of characters is correct.

3. A computer-implemented method as recited in claim 1, wherein the valid word or the portion of the valid word is based on a language model corresponding to a dictionary of valid words that pertain to a language.

4. A computer-implemented method as recited in claim 1, wherein the word fragment comprises a beginning portion of a valid word.

5. A computer-implemented method as recited in claim 1, wherein each word fragment in the set of word fragments comprises a correctly spelled word or an incorrectly spelled but often-used word.

6. A computer-implemented method as recited in claim 1, wherein the word fragment is correctable to become a valid word based on a correction model indicating that the word fragment is likely misspelled but intended to be the valid word.

7. A computer-implemented method as recited in claim 1, further comprising determining valid words for each word fragment in the set of word fragments.

8. A computer-implemented method as recited in claim 1, wherein determining which word fragment is most-likely correct is further based on a word-probability language model, the word-probability language model indicating a likelihood of correctness for each valid word.

9. Computer-readable storage media comprising instructions that are executable and, responsive to executing the instructions, cause a computing device to:
receive a user input corresponding to multiple characters;
analyze, based on a keypress model, the user input to determine a most-likely correct character of the multiple characters;
identify, based on a language model, one or more valid words having the most-likely correct character;
detect, based on a correction model, a potential spelling correction of a word fragment having the most-likely correct character and one or more additional previously received characters; and
predict one or more complete words based on a combination of the most-likely correct character, the one or more valid words, and the potential spelling correction.

10. Computer-readable storage media as recited in claim 9, wherein the instructions are executable to cause the computing device to predict the one or more complete words by expanding one or more branches of a dictionary trie to identify words likely to be used without expanding branches of the dictionary trie associated with words not likely to be used.

11. Computer-readable storage media as recited in claim 9, wherein the instructions are executable to cause the computing device to predict the one or more complete words by generating a predefined number of predicted complete words by expanding a most-probable path in a word-probability dictionary trie.

12. Computer-readable storage media as recited in claim 9, wherein the instructions are executable to cause the computing device to determine a maximum probability associated with the most-likely character to identify the one or more complete words.

13. Computer-readable storage media as recited in claim 9, wherein the instructions are executable to cause the computing device to determine a maximum probability of the most-likely character that is associated with a most-likely word.

14. Computer-readable storage media as recited in claim 9, wherein the instructions are executable to further cause the computing device to identify one or more subsequent child characters of the most-likely character that are associated with a most-likely word, the most-likely word correlating to a maximum probability of the most-likely character.

15. A computer-implemented method, comprising:
receiving a set of characters responsive to a user input to a virtual keyboard, the set of characters corresponding to the user input and based on characters of the virtual keyboard that are proximate a received location on the virtual keyboard of the user input, the set of characters continuing a word fragment;
determining, for each character of the set of characters, a selection probability that each character is correct based on the location;
determining spelling corrections of the word fragment to provide corrected word fragments;
determining, for each corrected word fragment of the corrected word fragments, a corrected probability that each corrected word fragment is correct based on a correction-probability model;
determining valid words for the word fragment and the corrected word fragments;
determining, for each valid word of the valid words for the word fragment and the corrected word fragments, a word probability that each valid word is correct based on a word-probability language model; and
predicting, based on the selection probability, the corrected probability, and the word probability, one or more complete words.

16. A computer-implemented method as recited in claim 15, wherein the selection probability is determined based on a percentage of the received location that corresponds to each respective character in the set of characters.

17. A computer-implemented method as recited in claim 15, wherein the received location is located between a plurality of virtual keys on the virtual keyboard.

18. A computer-implemented method as recited in claim 15, further comprising storing a single probability for each word in the word-probability language model.

19. A computer-implemented method as recited in claim 15, further comprising updating in real time probabilities associated with one or more words in the word-probability language model based on user-specific probabilities associated with complete words used by a particular user.

20. A computer-implemented method as recited in claim 19, wherein the updating further comprises adding one to a count associated with a total probability that is associated with complete words.
